(19) United States
(12) Patent Application Publication
(10) Pub. No.: US 2012/0318853 A1
(43) Pub. Date: Dec. 20, 2012

(54) HEATER BLOCK FOR WIRE BONDING SYSTEM

(75) Inventors: Wai Keong Wong, Bukit Rimau (MY); Jimmy Low, Puchong (MY); Raymund Francis Xavier, Puchong (MY)

(73) Assignee: FREESCALE SEMICONDUCTOR, INC, AUSTIN, TX (US)

(21) Appl. No.: 13/160,522

(22) Filed: Jun. 15, 2011

(51) Int. Cl. B23K 1/00; F27D 1/00

(52) U.S. Cl. 228/180.22; 228/4.5; 432/247

(57) ABSTRACT

A heater block for a wire bonding system includes a mounting base configured to receive a lead frame and a semiconductor die mounted on the lead frame. A heating structure is removably coupled to a top surface of the mounting base. The heating structure includes a central heating surface and side heating panels surrounding the central heating surface. The heating structure selectively heats wire bonding areas of the lead frame.

### BACKGROUND OF THE INVENTION

The present invention relates generally to wire bonding systems, and more particularly to a heater block for a wire bonding system.

Wire bonding systems typically are used to electrically connect an integrated circuit die to a chip carrier such as a lead frame using wires. Such systems include a heater block to heat the integrated circuit die and the lead frame to a temperature suitable for bonding.

Typically, the heater block is formed of a single piece of metal that supports the lead frame or chip carrier. During wire bonding, the entire lead frame surface is exposed to high temperatures, e.g., about 200° C., which leads to oxidation of copper elements of the lead frame. The oxidation typically initiates from a center runner of the lead frame adjacent to the heater element and propagates to the inner leads. Such excessive oxidation can be the cause of poor bonds between the wires and the leads of the lead frame.

Thus, there is a need for a wire bonding system that facilitates wire bonding but does not cause or reduces oxidation of the lead frame.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale. For example, the thicknesses of layers and regions may be exaggerated for clarity.

FIG. 1 is a block diagram of a wire bonding system in accordance with one embodiment of the present invention;

FIG. 2 illustrates an exemplary configuration of the heater block of the wire bonding system of FIG. 1 in accordance with one embodiment of the present invention;

FIG. 3 is a top view of the heater block of FIG. 2 with a heating structure attached to the heater block in accordance with one embodiment of the present invention;

FIG. 4 is a perspective view of the heating structure of FIG. 3 in accordance with one embodiment of the present invention; and

FIG. 5 is a top view of a semiconductor package undergoing a wire bonding operation using the wire bonding system of FIG. 1.

### DETAILED DESCRIPTION OF THE INVENTION

Detailed illustrative embodiments of the present invention are disclosed herein. However, specific structural and functional details disclosed herein are merely representative for purposes of describing example embodiments of the present invention. The present invention may be embodied in many alternate forms and should not be construed as limited to only the embodiments set forth herein. Further, the terminology used herein is for the purpose of describing particular embodiments only and is not intended to be limiting of example embodiments of the invention.

As used herein, the singular forms “a,” “an,” and “the,” are intended to include the plural forms as well, unless the context clearly indicates otherwise. It further will be understood that the terms “comprises,” “comprising,” “includes,” and/or “including,” specify the presence of stated features, steps, or components, but do not preclude the presence or addition of one or more other features, steps, or components.

It also should be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

In one embodiment, the present invention provides a heater block for a wire bonding system. The heater block includes a mounting base configured to receive a lead frame. A semiconductor die is mounted on the lead frame. A heating structure is removably coupled to a top surface of the mounting base. The heating structure includes a central heating surface and side heating panels surrounding the central heating surface. The heating structure selectively heats wire bonding areas of the lead frame.

In another embodiment, the present invention provides a method of wire bonding a semiconductor die to a lead frame. The method includes mounting the semiconductor die to the lead frame. The lead frame and the mounted semiconductor die are placed on a mounting base of a heater block of a wire bonding system. Wire bonding areas of the lead frame are selectively heated with a heating structure of the heater block and die pads of the semiconductor die are wire bonded to leads of the lead frame using bond wires.

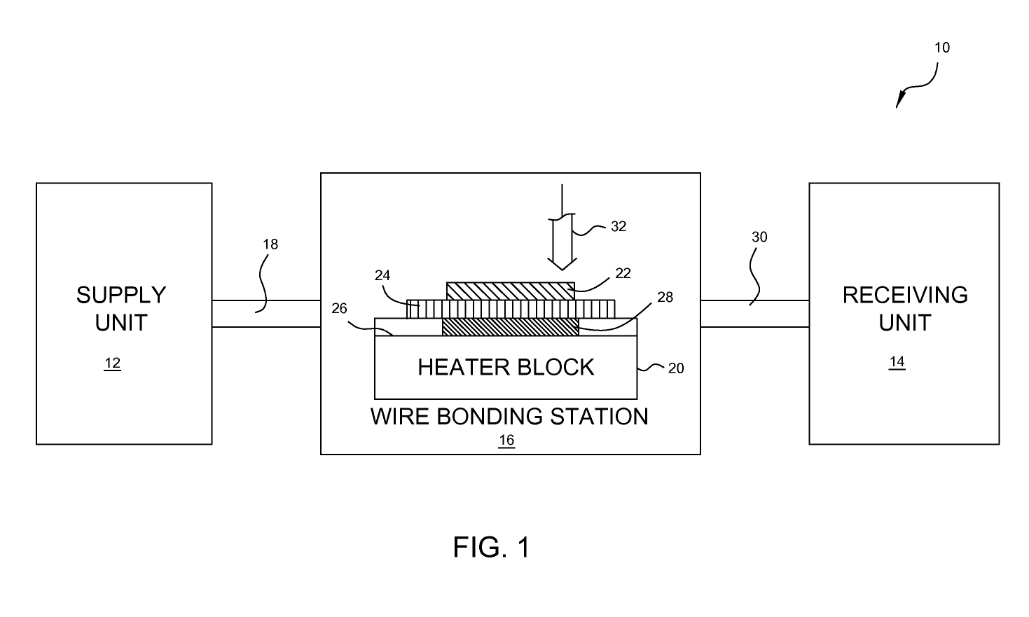

Referring now to FIG. 1, an exemplary configuration of a wire bonding system 10 in accordance with an embodiment of the present invention is illustrated. The wire bonding system 10 includes a supply unit 12, a receiving unit 14 and a wire bonding station 16 provided between the supply unit 12 and the receiving unit 14. The supply unit 12 holds a pre-determined number of lead frames that will undergo wire bonding at the wire bonding station 16. The lead frames from the supply unit 12 may be transported to the wire bonding station 16 using automated transportation mechanisms such as through guide rails 18.

The wire bonding station 16 includes a heater block 20 to facilitate wire bonding of a semiconductor die 22 to a lead frame 24. The heater block 20 includes a mounting base 26 configured to receive the lead frame 24, which has the semiconductor die 22 mounted on the lead frame 24. The heater block 20 also includes a heating structure 28 removably coupled to a top surface of the mounting base 26. The heating structure 28 is configured to selectively heat wire bonding areas of the lead frame 24.

The receiving unit 14 receives the lead frames on which wire bonding at the wire bonding station 16 has been completed. An automated transport mechanism may be used to move the lead frame assemblies (lead frames, dies wire bonded thereto) from the wire bonding station 16 to the receiving unit 14, such as guide rails 30. The wire bonding station 16 includes other components such as a capillary 32, integrated heating elements and so forth.

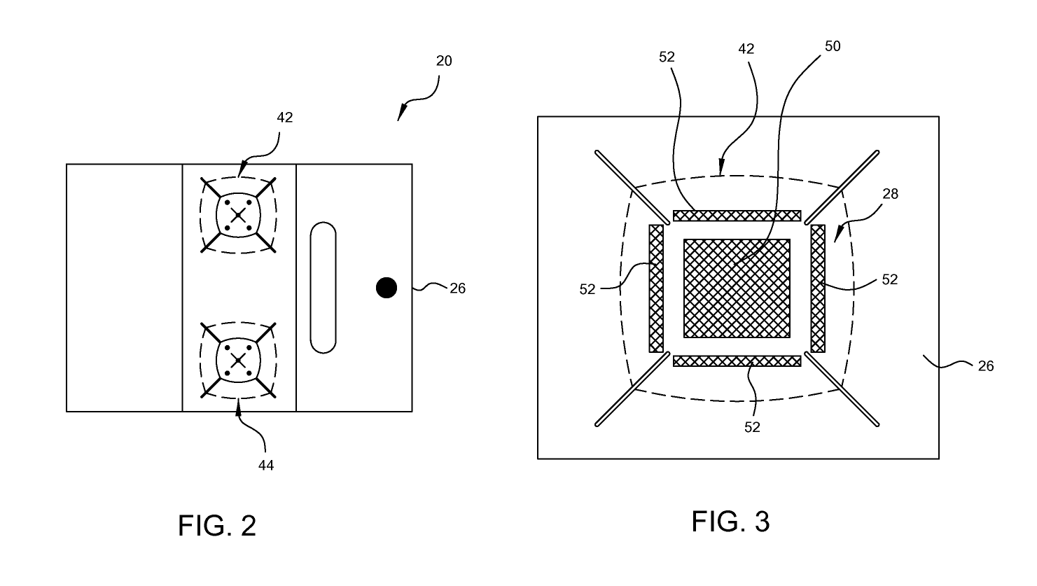

FIG. 2 illustrates an exemplary configuration of the heater block 20 of the wire bonding system 10 of FIG. 1. As illustrated, the heater block 20 includes the mounting base 26 for supporting the lead frame 24 thereon. In the illustrated embodiment, the mounting base 26 is formed with a thermally insulating material. Examples of thermally insulating materials include ceramic and plastic. In the illustrated embodiment, the heater block 20 includes two heating areas 42 and 44. However, the heater block 20 may include a greater or lesser number of heating areas. The heating areas 42 and 44 include integrated heating elements for heating a lead frame.

FIG. 3 is an enlarged top view of the heating area 42 of the heater block 20 of FIG. 2 with the heating structure 28 attached to the mounting base 26. In one embodiment of the present invention, the heating structure 28 is removably coupled to the mounting base 26. The heating structure 28 may be coupled to the mounting base 26 using an adhesive or a fastener. However, other suitable coupling mechanisms may be are within the scope of the invention.

The heating structure 28 includes a central heating surface 50 and side heating panels 52 surrounding the central heating surface 50 to selectively heat wire bonding areas of a lead frame supported on the mounting base 26. The central heating surface 50 and the side heating panels 52 are formed of a thermally conductive material. In one exemplary embodiment, the central heating surface 50 and the side heating panels are formed of corrosion resistant steel, such as Corrax®, which is available from Uddenholms AKTiebolag of Sweden.

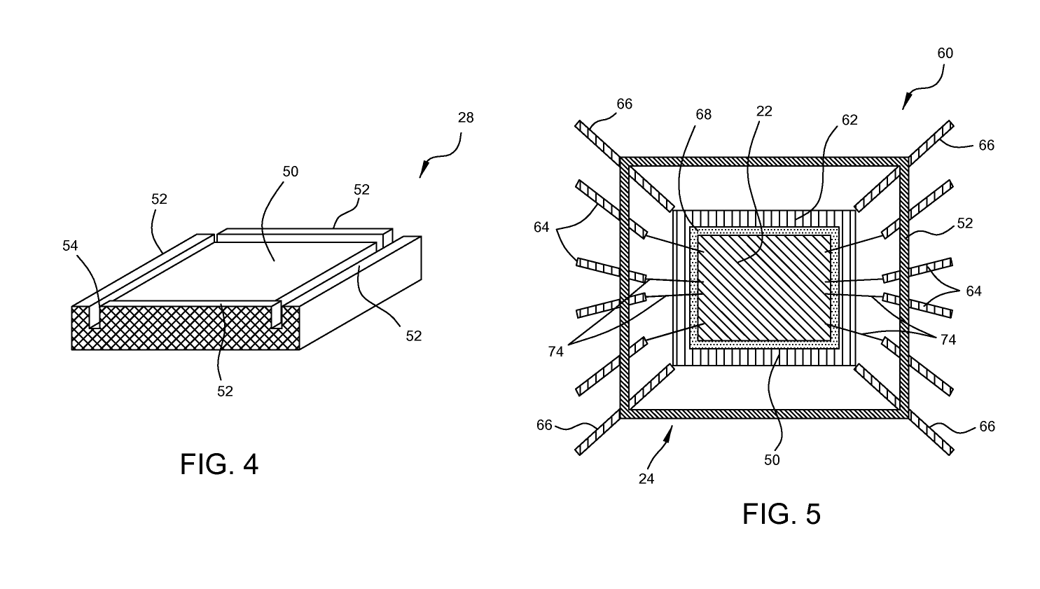

FIG. 4 is a perspective view of the heating structure 28 of FIG. 3 in accordance with one embodiment of the present invention. As illustrated, the heating structure 28 is generally rectangular and includes the central heating surface 50 and four side heating panels 52. The central heating surface 50 and the side heating panels 52 are configured to selectively heat wire bonding areas of the lead frame 24 to facilitate wire bonding die bonding pads of the semiconductor die 22 (FIG. 1) to leads of the lead frame 24. That is, the central heating area 50 is spaced from the side heating panels 52 with channels 54. Only the areas of the lead frame 24 that are in contact with the central heating area 50 and the side heating panels 52 are directly heated. In one embodiment, the channels 54 are 1.0 mm to 4.0 mm wide. More particularly, the central heating area 50 heats the die flag 62 and the side heating panels 52 heat only that portion of the lead fingers 64 (FIG. 5) where bond wires will be attached. The remaining portions of the lead frame 24 that are not in contact with the central heating surface 50 and the side heating panels 52 are isolated from the heat source in order to reduce lead frame oxidation. In certain embodiments, a thickness of the central heating surface 50 and the side heating panels 52 is in a range of about 5 mm to about 15 mm.

FIG. 5 is a top plan view of a semiconductor package assembly 60 comprising the lead frame 24 having a die flag 62 and lead fingers 64, a die 22, and bond wires 74 extending between respective ones of the lead fingers 64 and die bonding pads on an active surface of the die 22. Also shown are lead frame tie bars 66 that extend from corners of the die flag 62, as is known by those of skill in the art.

The semiconductor die 22 is mounted on the die flag 62 of the lead frame 24 using a die attach adhesive 68 such as epoxy. The lead frame 24 and attached semiconductor die 22 are mounted on the mounting base 26. Then, only the die flag 62 on the central heating area 50 and portions of the lead fingers 64 resting on the side heating panels 52 are heated. Heating is done with heater elements placed under the heater block 20. While it is also possible to place heating element inside the heater block 20, this method is not preferred because it complicates the heater block design and increases cost. The lead frame 24 then undergoes selective heating. Subsequently, the bonding pads of the semiconductor die 22 are electrically connected to the lead fingers 64 of the lead frame 24 using bond wires 74 via a wire bonding process. The wires 74 are formed from a conductive material such as aluminium or gold.

The present invention allows for selective heating of the wire bonding areas using the heating structure 28 while other parts of the lead frame 24 are isolated from the heating block, which reduces oxidation of the lead frame 24.

The present invention, as described above, allows for selective heating of wire bonding areas of the lead frame thereby reducing the energy requirements of the wire bonding system. Moreover, the non-functional areas of the lead frame are isolated from the heating areas thereby making the packages less susceptible to delamination issues and enhancing the reliability of such packages.

The technique employs attaching a heating structure attached to an insulative mounting base of the heater block. The heating structure includes a central heating surface and side heating panels configured to selectively heat the wire bonding areas of the lead frame while isolating the other areas of the lead frame from the heat source.

By now it should be appreciated that there has been provided an wire bonding system and a method of wire bonding a semiconductor die to a lead frame. Although the invention has been described using relative terms such as “front,” “back,” “top,” “bottom,” “over,” “under” and the like in the description and in the claims, such terms are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

The use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Although the invention is described herein with reference to specific embodiments, various modifications and changes can be made without departing from the scope of the present invention as set forth in the claims below. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

1. A heater block for a wire bonding system, comprising:
a mounting base configured to receive a lead frame and a semiconductor die mounted on the lead frame; and
a heating structure removably coupled to a top surface of the mounting base, the heating structure comprising a central heating surface and side heating panels surrounding the central heating surface, wherein the heating structure selectively heats wire bonding areas of the lead frame.

2. The heater block of claim 1, wherein the mounting base comprises an insulating material.

3. The heater block of claim 2, wherein the mounting base comprises ceramic, or plastic, or combinations thereof.

4. The heater block of claim 1, wherein the central heating surface is configured to heat a die flag of the lead frame and the side heating panels are configured to heat bond areas of the lead frame.

5. The heater block of claim 1, wherein the heating structure comprises integrated heating elements.

6. The heater block of claim 1, wherein the heating structure is coupled to the mounting base using an adhesive or a fastener.

7. The heater block of claim 1, wherein the heating structure comprises a thermally conductive material.

8. The heater block of claim 7, wherein the heating structure comprises a metal.

9. The heater block of claim 1, wherein the mounting base is attached to the wire bonding system.

10. A heating structure for a heater block of a wire bonding system, comprising:
a central heating surface configured to heat a die flag of a lead frame; and
side heating panels disposed about the central heating surface, wherein the central heating surface and the side heating panels are configured to selectively heat wire bonding areas of the lead frame for wire bonding die bonding pads of a semiconductor die to leads of the lead frame.

11. The heating structure of claim 10, wherein the heating structure is removably coupled to the heater block.

12. The heating structure of claim 11, wherein the heating structure is coupled to an insulative mounting base of the heater block.

13. The heating structure of claim 11, wherein the central heating surface and the side heating panels comprise a thermally conductive material.

14. The heating structure of claim 11, wherein a thickness of the central heating surface and the side heating panels is in a range of about 5 mm to about 15 mm.

15. The heating structure of claim 11, wherein the heating structure is generally rectangular and comprises four side heating panels.

16. A method of wire bonding a semiconductor die to a lead frame, the method comprising:
mounting the semiconductor die to the lead frame;
placing the lead frame and the mounted semiconductor die on a mounting base of a heater block of a wire bonding system;
selectively heating wire bonding areas of the lead frame with a heating structure of the heater block; and
wire bonding die pads of the semiconductor die to leads of the lead frame using bond wires.

17. The method of wire bonding of claim 16, further comprising isolating selective areas of the heater block from the heating structure.

18. The method of wire bonding of claim 16, wherein the mounting base comprises an insulating material.

19. The method of wire bonding of claim 16, wherein the heating structure comprises a thermally conductive material.

20. The method of wire bonding of claim 16, wherein the heating structure comprises a central heating surface and side heating panels that heat the wire bonding areas of the lead frame.
